(19) United States
(12) Patent Application Publication
(10) Pub. No.: US 2016/0009580 A1
(43) Pub. Date: Jan. 14, 2016

(54) WASTEWATER TREATMENT SYSTEM AND METHODS

(71) Applicant: ALCOA INC., Pittsburgh, PA (US)

(72) Inventors: Janean Elbicki, Pittsburgh, PA (US); Shannon Parks, Sarver, PA (US); Dennis L. Fulmer, Greensburg, PA (US); John R. Smith, Pittsburgh, PA (US)

(21) Appl. No.: 14/795,419

(22) Filed: Jul. 9, 2015

Related U.S. Application Data
(60) Provisional application No. 62/023,304, filed on Jul. 11, 2014.
(60) Provisional application No. 62/025,791, filed on Jul. 17, 2014.

(51) Int. Cl. C02F 3/30; C02F 3/28; C02F 1/28; C02F 3/10

(52) U.S. Cl. CPC C02F 3/30; C02F 3/10; C02F 3/2813; C02F 1/281; C02F 1/286; C02F 2003/008

(57) ABSTRACT

The instant disclosure is directed towards methods of treating wastewater and related systems, where the system includes: an aerated zone comprising media (e.g. with sufficient surface area and porosity to sustain microbial growth and retain bacteria) and a non-aerated zone comprising compost, wherein the system is configured to remove emulsified oil (e.g. and grease) from a wastewater stream.

### CROSS-REFERENCE TO RELATED APPLICATIONS

This application is a non-provisional of and claims priority to U.S. Provisional Application Ser. Nos. 62/023,304 filed Jul. 11, 2014 and 62/025,791 filed Jul. 17, 2014, both entitled “Wastewater Treatment System and Methods”, both of which are incorporated by reference in their entirety.

### FIELD OF THE INVENTION

Generally, the instant disclosure is directed towards a wastewater treatment system for removing contaminants, including (but not limited to) emulsified oils and grease, organics, inorganics (polychlorinated biphenyls, or PCBs), and metals from wastewater (e.g. to a quality suitable for permitted discharge, recycle, and/or reuse). More specifically, the instant disclosure is directed towards a system including at least two zones for wastewater treatment, including an aerated portion having media therein with a sufficient average surface area to support and promote microorganism growth and a non-aerated (e.g. anoxic or anaerobic) portion including compost, wherein via both the aerated and non-aerated portions, up to 95% of emulsified oil is removed from the wastewater (e.g. with an inlet emulsified oil content not exceeding about 3500 ppm).

### BACKGROUND

Prior to discharge into the environment or recycle for beneficial use, wastewater must generally be within certain prescribed limits for various contaminant levels. Conventional wastewater treatment systems may be onerous, costly, time consuming, and require a high amount of energy to run and operate the system.

### SUMMARY OF THE DISCLOSURE

Broadly, the present disclosure relates to systems and methods for treating wastewater. More specifically, the instant disclosure is directed towards removing emulsified oils and grease from a wastewater stream via a wastewater system having at least two zones, including: a first aerated zone (e.g. aerobic) comprising media (e.g. rock) with sufficient surface areas and porosity; and a second zone comprising a non-aerated compost (e.g. anoxic or anaerobic). In some embodiments, the system includes a third zone, which is an aerated zone, with media having a sufficient surface area and porosity to support and promote microorganism (e.g. aerobic bacteria) growth and retention in the zone.

Without being bound to a particular mechanism or theory, it is believed that the combination of these two zones (and/or components) is combinable to yield a wastewater treatment system which is configured to remove emulsified oil from a wastewater stream, where the emulsified oil is otherwise not biodegradable and/or separable from the wastewater (e.g. using traditional separation techniques).

Without being bound by a particular mechanism or theory, it is believed that one or more of the following mechanisms contribute to oil and grease removal from the emulsified oil content in the wastewater stream, including: microorganisms present in the media in the aerated zone (e.g. aerobic bacteria); adsorption onto the media in the first zone; microorganisms present in the non-aerated zone (e.g. compost) (e.g. anoxic and/or anaerobic bacteria); and/or adsorption onto the compost.

Without being bound by a particular mechanism or theory, it is believed that the compost zone is configured to provide two functions, including: (1) adsorption of at least a portion of oil from the emulsified oil in the wastewater stream and (2) by retaining the oil, and/or by consisting of a media which is an organic material, providing a carbon source to promote/facilitate the microorganisms that act to: (a) metabolize/break down the oil and grease and/or (b) perform denitrification, to transform nitrates into nitrogen gas.

As used herein, “wastewater” means: water having impurities and/or contaminants therein. In some embodiments, wastewater includes: sanitary wastewater, industrial (or process) wastewater, storm water (e.g. run-off) and/or combinations thereof. As some non-limiting examples, wastewater treated in accordance with one or more embodiments of the instant disclosure can include the following contaminants/impurities: emulsified oil & grease, including emulsified oils and greases having surfactants, additives and/or emulsifiers therein. As some additional non-limiting examples, wastewater treated in accordance with the instant disclosure can include the following contaminants/impurities: oil, grease, ammonia, phosphorous, heavy metals (e.g. arsenic, mercury, chromium), and others.

As used herein, “treated water” means: water meeting the purity limits as set by regulations set by various government and/or regulatory bodies. In some embodiments, the systems and methods of the instant disclosure transform wastewater into treated water (i.e. by cleaning and polishing the wastewater stream). In some embodiments, treated water is discharged to a holding tank for reuse (recycle). In some embodiments, treated water is discharged to a drainage field, into a body of water, or used for irrigation purposes.

As used herein, “cleaned water” means water that has undergone a cleaning step to remove contaminants (e.g. via the aerated portion).

As used herein, “polished water” means: water that has undergone removal of additional suspended solids and BOD from effluent (e.g. after a cleaning step, via the non-aerated compost portion).

As used herein, “inlet” means: a location where something enters. In one embodiment, wastewater enters each zone through an inlet in liquid communication with the zone.

As used herein, “outlet” means: a location where something exits. In one embodiment, wastewater exits each zone through an outlet in liquid communication with the zone.

As used herein, “zone” means: an area that is different from another areas in a particular way. As a non-limiting example, the wastewater treatment system includes at least two zones: an aerated zone (e.g. aerobic) and a non-aerated zone (e.g. anoxic or anaerobic).

In one embodiment, the zones (aerated zone and non-aerated zone) are set apart by different chambers, where the chambers are in liquid communication with each other via a port (e.g. effluent from one chamber that is an influent into the other chamber). In some embodiments, the zones are in a single chamber (e.g. a tank having a bottom, at least one sidewall, and an inlet and outlet configured to direct wastewater into and out of the tank). In some embodiments, the aerated and non-aerated zones are separable with one or more baffles. In some embodiments, the zones include media.

As used herein, “media” means: a substance having a surface area. In some embodiments, the first zone comprises media configured with a sufficient surface area and/or porosity to provide a surface area for bacteria to adhere to and/or a habitat for bacteria to live in.

Some non-limiting examples of media for the aerated zone include: aggregate (e.g. rocks, pea gravel, stones), sand, lava rocks, ceramic beads, plastics (e.g. BioRings™), polymers, and the like. Further, it is noted that the size and shapes of the media are variable in accordance with one or more embodiments of the instant disclosure in order to provide a desired surface area of media per unit volume of material. Some non-limiting examples of media in the non-aerated zone include compost and/or amended compost (e.g. compost with a portion of clay, i.e. bauxite residue).

As used herein, “aeration” means: the process of directing (e.g. circulating) air through something. In some embodiments, the wetland cell comprises aeration to provide air (including oxygen, or dissolved oxygen) to the water present in the wetland. In some embodiments, aeration comprises bubbling oxygen gas into the water. In some embodiments, aeration comprises bubbling air (e.g. atmospheric air), which includes oxygen gas (along with nitrogen gas and carbon dioxide) into the water.

As used herein, “aerobic” means: a region which has the capability to support aerobic bacteria.

As used herein, “anaerobic zone” means: a region which has the capability to support anaerobic bacteria.

As used herein, “anoxic zone” means: a region which has the capability to support microaerophilic bacteria.

In some embodiments, the non-aerated zone includes media. In some embodiments, via aeration, non-aeration, or as a function of the composition of the media and the microorganisms in the surrounding environment, the non-aerated zone is anaerobic, anoxic, aerobic, and combinations thereof (e.g. depending on the prevalence of oxygen in the outlet of the aerated zone and the oxygen demand of the media in the non-aerated zone).

As a non-limiting example, the media includes compost (e.g. spent mushroom compost). In some embodiments, the compost is an amended compost (e.g. having a weight percentage of bauxite residue).

As used herein, “compost” means: a mixture of decayed organic matter.

As used herein, “porosity” means: the ratio of the volume of interstices of a material to the volume of its mass.

In some embodiments, the aerated zone includes an aeration system. As used herein, “aeration system” means: a system for producing aeration in a material. In some embodiments, the aeration system aerates the wastewater before it comes into and/or as it enters/travels through the first portion.

In some embodiments, the aeration system includes the following components: a pump, a gauge, an inlet, an outlet (e.g. in the wetland), and piping (to direct the air from the pump through the inlet to the outlet). In some embodiments, the outlet comprises the open end of the piping. In some embodiments, the outlet comprises a plurality or perforations which allow the air to bubble there through. In some embodiments, the outlet is configured with a diffuser, which is configured to diffuse the large air bubbles into smaller air bubbles. In some embodiments, the aeration is adjustable (e.g. coarse bubbles, fine bubbles), such that aeration in a portion or all of the aeration zone is configured to be increased, decreased, or varied from one portion of the zone to another portion of the zone.

In some embodiments, the components of the aeration system which are located within the aeration zone are referred to as the aeration device. In some embodiments, the aeration device is located in the inlet of the aerated zone. In some embodiments, the aeration device is located proximate to a section of the aeration zone. In some embodiments, the aeration device is located throughout (along the vertical and/or horizontal length of) the aerated zone. In some embodiments, the aeration system is located along the bottom portion of the aerated zone.

As used herein, “baffle” means: an obstruction for deflecting the flow of a material. In some embodiments, the baffles are constructed of various non-reactive (non-degrading) materials. In some embodiments, the baffles comprise a vertical configuration, a horizontal configuration, a curved (arcuate) configuration, or an angled configuration. In some embodiments, the baffles include a solid wall. In some embodiments, the baffles comprise a perforated wall (with holes in the wall, such that the velocity of the water flow is slowed though the water is still permitted to pass through the baffle). In one or more embodiments, the dimension and shape of the baffles can be varied as desired. In some embodiments, baffles are utilized to separate the aerated zone from the non-aerated zone and direct the flow of water through the two zones of the chamber (i.e. and prevent short circuiting).

As used herein, “oxidation reduction potential” (ORP) is: a measurement of water's ability to oxidize contaminants. For example, the higher the ORP, the greater the number of oxidizing agents. As a non-limiting example, an aerobic ORP corresponds to a range of +100 to +250 mV. As a non-limiting example, an anaerobic ORP corresponds to a range of: −100 to −250 mV. As a non-limiting example, an anoxic ORP corresponds to a range of: 0 to −150 mV. As a non-limiting example, an ORP in the range of 0 to 100 mV would correspond to a transition range (i.e. the range between anoxic and aerobic).

As used herein, “chemical oxygen demand” means: a standard method for indirect measurement of the amount of organic pollution (that cannot be oxidized biologically) in a sample of water. In environmental chemistry, the chemical oxygen demand (COD) test is commonly used to indirectly measure the amount of organic compounds (e.g. oil and grease) in water.

As used herein, “dissolved oxygen” (also called DO) means: the amount of oxygen dissolved in water, measured in ppm. For example, oxygen saturation for a wastewater stream is dependent upon the temperature of the wastewater.

As used herein, “hydraulic retention time” means: the amount of time the water spends moving through a volume of material.

In some embodiments, the hydraulic retention time in the first and second portions is: at least 0.25 day; at least 0.50 day; at least 0.75 day; at least 1 day; at least 1.25 day; at least 1.5 day; at least 1.75 day; at least 2 days; at least 2.25 day; at least 2.50 day; at least 2.75 day; at least 3 day; at least 3.25 day; at least 3.5 day; at least 3.75 day; at least 4 days; at least 4.25 day; at least 4.50 day; at least 4.75 day; or at least 5 day.

In some embodiments, the hydraulic retention time in the first and second portions is: at least 5 days; at least 6 days; at least 7 days; or at least 8 days.

In some embodiments, the hydraulic retention time in the first and second portions is: not greater than 5 days; not greater than 6 days; not greater than 7 days; or not greater than 8 days.

In some embodiments, the hydraulic retention time in the first and second portions is: not greater than 0.25 day; not greater than 0.50 day; not greater than 0.75 day; not greater than 1 day; not greater than 1.25 day; not greater than 1.5 day; not greater than 1.75 day; not greater than 2 days; not greater than 2.25 day; not greater than 2.50 day; not greater than 2.75 day; not greater than 3 day; not greater than 3.25 day; not greater than 3.5 day; not greater than 3.75 day; not greater than 4 days; not greater than 4.25 day; not greater than 4.50 day; not greater than 4.75 day; or not greater than 5 day.

As used herein, “flowing” means: moving in or as in a stream.

As used herein, “directing” means: guiding the course of. In the case of wastewater, the water is directed into the aerated zone or non-aerated zone via, e.g. head pressure, gravity, an inlet, and combinations thereof, to name a few.

In some embodiments, the aerated zone and non-aerated zone are part of an engineered wetland. As used herein, “engineered wetland” means: a non-naturally occurring wetland. In some embodiments, the engineered wetland comprises an impermeable barrier (liner) which retains a media therein. In some embodiments, the wetland is a horizontal subsurface flow wetland. In some embodiments, the wetland retains media. In some embodiments, the wetland supports vegetation, which grows in the wetland and/or is rooted in the media retained in the wetland.

As used herein, “emulsified” means: any colloidal suspension of a liquid in another liquid. For example, a colloidal suspension is a concentration of particles or droplets (e.g. oil) dispersed (e.g. homogenously) through the carrier liquid (water).

In some embodiments, the emulsified oil comprises surfactants. In some embodiments, the emulsified oil comprises emulsifying agents. In some embodiments, the emulsified oil will not separate, due to the presence of emulsifying agents, surfactants, and/or other additives.

In some embodiments, the emulsified oil comprises: at least 50 to not greater than 3500 ppm in wastewater. In some embodiments, the method provides removal of emulsified oil, which does not separate from water during a separation step (e.g. separation is capable of removing “free phase” oil, not emulsified oil in water).

In some embodiments, the oils include: mineral oils, aliphatic compounds, hydraulic oil, pump oils, vegetable oil, hydrotreated oil (e.g. carbon chains having increased saturation), naphthenic oil, and blends/combinations thereof. In some embodiments, the emulsified oil is not readily biodegradable.

In one aspect of the instant disclosure, a method of treating wastewater is provided, comprising: flowing a wastewater stream comprising an emulsified oil content of not greater than 3500 mg/L through a chamber at a hydraulic retention time of not greater than 5 days, the chamber comprising: a bottom and at least one sidewall, an influent end and an effluent end in liquid communication with a control volume in the tank, wherein the control volume is configured to retain the wastewater stream, the chamber comprising: an aerated zone and a non-aerated zone; wherein the aerated zone includes: a media configured to provide a surface for microorganisms to adhere to, wherein the media has an average surface area of not greater than 2.0 cm²/g; wherein the media comprises a porosity of not greater than 50%; wherein the non-aerated portion includes compost (e.g. decayed organic matter); treating the wastewater in the chamber via the two zones) to remove at least 85% of emulsified oil & grease from the wastewater stream to provide a treated water stream; and discharging the treated water stream from the chamber.

In another aspect of the instant disclosure, a method is provided, comprising: flowing wastewater having a first emulsified oil content of not greater than 3500 mg/L through an aerated zone having media therein, (e.g. the media having a surface area and porosity sufficient to sustain microbial growth and retention as water flows through the zone), wherein via the aerated zone a portion of the emulsified oil is removed to provide a cleaned water stream; flowing the cleaned water stream having a second emulsified oil content through a non-aerated zone having compost therein, wherein the second emulsified oil content is lower than the first emulsified oil content, wherein via the non-aerated zone of compost a portion of the emulsified oil in the cleaned water stream is removed to provide a polished water stream, the polished water stream comprising a third emulsified oil content, wherein the third emulsified oil content is lower than the second emulsified oil content; and discharging a polished water stream from the non-aerated zone.

In some embodiments, the hydraulic retention time is from 0.5 days to 5 days.

In some embodiments, the hydraulic retention time is not greater than 0.5 days.

In some embodiments, the media has an average surface area of not greater than 0.5-2.0 cm²/g.

In some embodiments, the average surface area of the media is: not greater than 0.5 cm²/g; not greater than 1 cm²/g; not greater than 1.5 cm²/g; or not greater than 2 cm²/g. In some embodiments, the average surface area of the media is: at least 0.5 cm²/g; at least 1 cm²/g; at least 1.5 cm²/g; or at least 2 cm²/g.

In some embodiments, the media comprises a porosity of at least 25% porosity to not greater than 50% porosity.

In some embodiments, the media porosity is: at least 25%; at least 30%; at least 35%; at least 40%; at least 45%; or at least 50%. In some embodiments, the media porosity is: not greater than 25%; not greater than 30%; not greater than 35%; not greater than 40%; not greater than 45%; or not greater than 50%.

In some embodiments, the chamber comprises an engineered wetland.

In some embodiments, the wetland is a subsurface flow wetland (e.g. horizontal subsurface flow).

In some embodiments, the aerated zone is configured with an aeration system.

In some embodiments, the aeration system is configured to provide oxygen-containing air to the wastewater in the aerated zone.

In some embodiments, the treating step comprises at least one of: the microorganisms in the aerated portion (e.g. aerobic bacteria); adsorption onto the media; the microorganisms in the compost portion (e.g. anaerobic bacteria); and adsorption onto the compost; and combinations thereof.

In some embodiments, the wastewater comprises a pH of 6.5 to not greater than 8.5.

In some embodiments, the method comprises directing the water through a second zone of aerobic media.

In some embodiments, prior to the discharging step, the method comprises directing the polished wastewater stream through a sensor zone, where the sensor is configured to measure the oil content in the water.

In some embodiments, the sensor is configured with a control system, wherein (e.g. when the oil content is above a certain threshold limit) the control system is configured to redirect the water through a feedback loop (e.g. through at least one of the first and second zones) to remove additional oil and grease.

In some embodiments, the system is configured to operate in cold weather conditions (e.g. temperatures down to about 40° F.).

In some embodiments, the method comprises removing at least 85% to greater than 95% of Cr. from the wastewater stream.

In some embodiments, the method comprises removing at least 85% to greater than 92% of Al from the wastewater stream.

In some embodiments, the method comprises removing at least 95% to greater than 99% of Zn from the wastewater stream.

In some embodiments, the method comprises removing at least 75% to greater than 98% of PCBs from the wastewater stream.

In some embodiments, the method comprises removing at least 90% PCBs from the wastewater stream.

In some embodiments, the method comprises removing an average of 95% of PCBs from the wastewater stream.

In some embodiments, the method comprises removing up to 92% of COD.

In some embodiments, the method is configured to treat wastewater having an influent COD of 11,000 mg/L (e.g. 11,050 mg/L).

In some embodiments, the method comprises removing up to 95% of oil and grease.

In some embodiments, the method is configured to treat wastewater having an influent oil content of up to 3100 mg/L.

In some embodiments, the method comprises removing oil from a wastewater stream to below permit levels (e.g. below 20 ppm).

In some embodiments, the method comprises removing at least 50% ammonia from the wastewater stream.

In some embodiments, the method is configured to reduce water toxicity.

In some embodiments, the system includes baffles in the first portion/zone. In some embodiments, the system includes baffles in the second portion/zone. In some embodiments, the system includes baffles in both the first zone and the second zone.

In some embodiments, the system is configured to remove at least 50% up to 92% removal of nitrate.

In another aspect of the instant disclosure, a wastewater treatment system is provided comprising: an aerated zone having media therein (rocks), the aerated portion having water therein, the water having a dissolved oxygen saturation of at least 50% of its saturation limit, and a non-aerated zone having compost therein.

In some embodiments, directing the wastewater though an engineered wetland further comprises aerating the wastewater as it travels through the engineered wetland.

In some embodiments, the aerated zone (e.g. wetland portion) comprises an aeration system along the bottom portion. In some embodiments, the aeration system comprises a series of aeration devices configured to provide oxygen (e.g. air having oxygen in it, or oxygen gas) to the microorganisms attached to the growth media (to feed the microorganisms and promote degradation of organics such as nitrogen, BOD and COD).

In some embodiments, the aeration zone (e.g. wetland portion) is sufficiently aerated to remove contaminants from wastewater. As used herein, “sufficiently aerated” meet or exceed theoretical oxygen demand (based on COD, BOD, NH₃) for an influent WW stream. In some embodiments, sufficiently aerated includes having a dissolved oxygen content of at least about 60% of saturation (where dissolved oxygen content is specific to the water temperature of the wastewater). In some embodiments, the DO is at least 2 ppm.

In some embodiments, aerating is sufficient to provide wastewater having a dissolved oxygen content of at least about 50% of saturation up to 90% saturation, for that water temperature. In some embodiments, aerating is sufficient to provide wastewater having a dissolved oxygen content of at least about 60% of saturation up to 80% of saturation, for the particular water temperature. In some embodiments, aerating is sufficient to support and sustain aerobic bacteria.

In one embodiment, aeration devices are set up parallel to the direction of water flow. In one embodiment, the aeration devices are set up perpendicular to the wastewater flow. In one embodiment, the aeration devices are set up angled to the direction of the water flow. In one embodiment, the aeration devices are set up in a combination of at least parallel, perpendicular, and angled with respect to the direction of water flow through the wastewater treatment stream. In one embodiment, liquid oxygen is dispersed into the wastewater stream as it enters aerobic zone.

Various ones of the inventive aspects noted hereinabove may be combined to yield a wastewater treatment system or method of using such system to remove contaminants and impurities from a wastewater stream.

These and other aspects, advantages, and novel features of the invention are set forth in part in the description that follows and will become apparent to those skilled in the art upon examination of the following description and figures, or may be learned by practicing the invention.

### BRIEF DESCRIPTION OF THE DRAWINGS

FIG. 1 depicts a flow chart of an embodiment of a wastewater treatment method in accordance with the instant disclosure.

FIG. 2 depicts a flow chart of another embodiment of a wastewater treatment method in accordance with the instant disclosure.

FIG. 3A depicts a flow diagram of the wastewater treatment system, depicting the wastewater having an emulsified oil stream being directed into the wastewater treatment system (via the inlet/influent), the system having: an aerated zone with media there in (e.g. rocks) a non-aerated zone with media therein (e.g. compost) and discharging a cleaned, polished water sample (via the outlet/effluent).

FIG. 3B depicts a flow diagram of another wastewater treatment system, illustrating an oil/water sensor positioned adjacent to the effluent from the non-aerated portion, such that the oil/water sensor determines whether the oil content of the water is below a certain threshold. To the extent that the oil content of the water is below a certain threshold level/amount (e.g. below permit levels), the wastewater exits the wastewater treatment system. To the extent that the oil content is above the threshold amount, a control system (e.g. piping and valve) flows water either: (a) back to the aerated zone, to flow through the aerated and non-aerated zones or (b) back to the non-aerated portion, to flow through the non-aerated portion.

FIG. 4 is a chart of data showing a 4 Day HRT and 2-Day HRT. As depicted by FIG. 4, the micro-organisms are depleting more of the Dissolved Oxygen as it passes through chamber during 2-Day HRT.

FIG. 5 is a chart of data showing that dissolved oxygen is inversely proportional to COD (Blue line). As the COD spikes up, DO begins to spike down. In the aerobic section, micro-organisms consume more oxygen, thus DO decreases, as more food is available.

FIG. 6 depicts a flow chart of an embodiment of a wastewater treatment system in accordance with the instant disclosure.

FIG. 7 is a table of experimental data from a “cold weather” unit.

FIG. 8 is a graph of COD over time, for the cold weather unit.

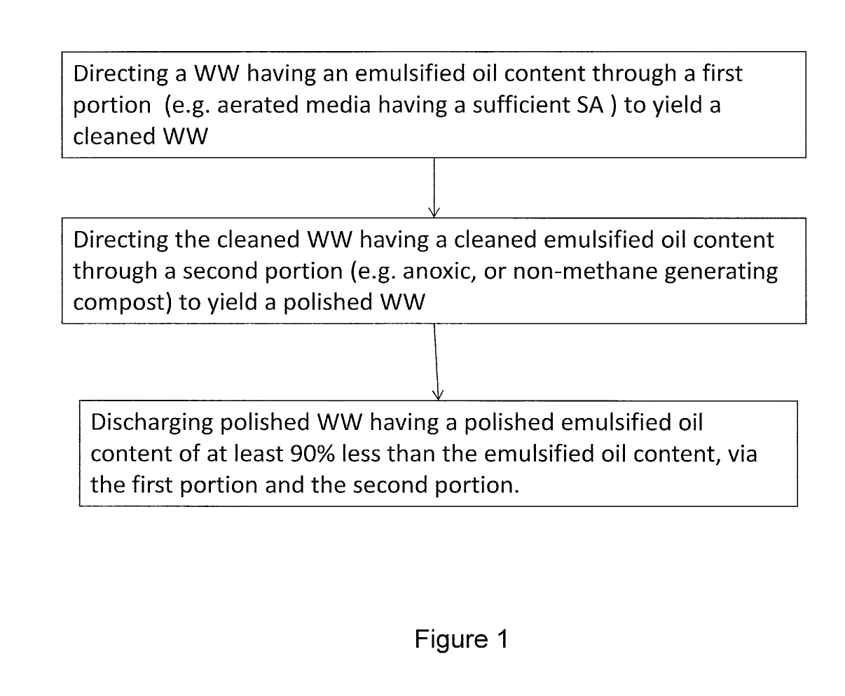

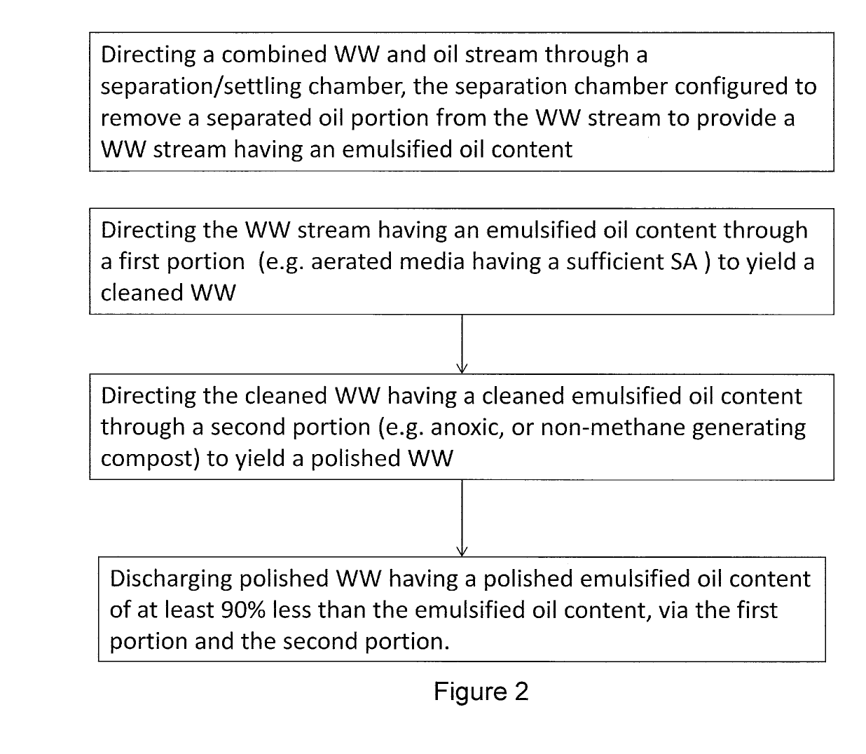

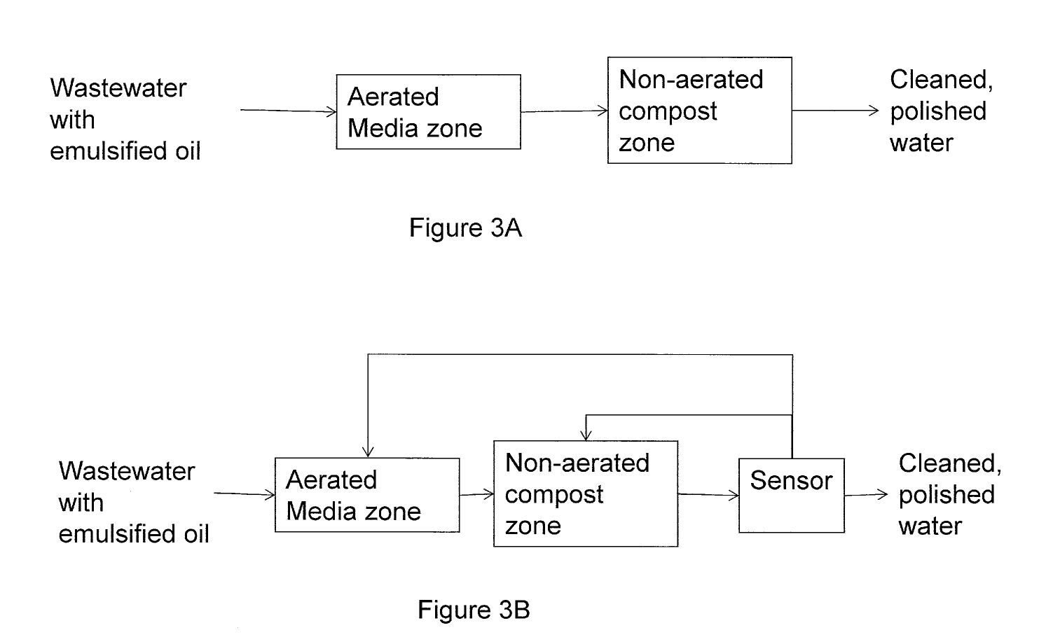

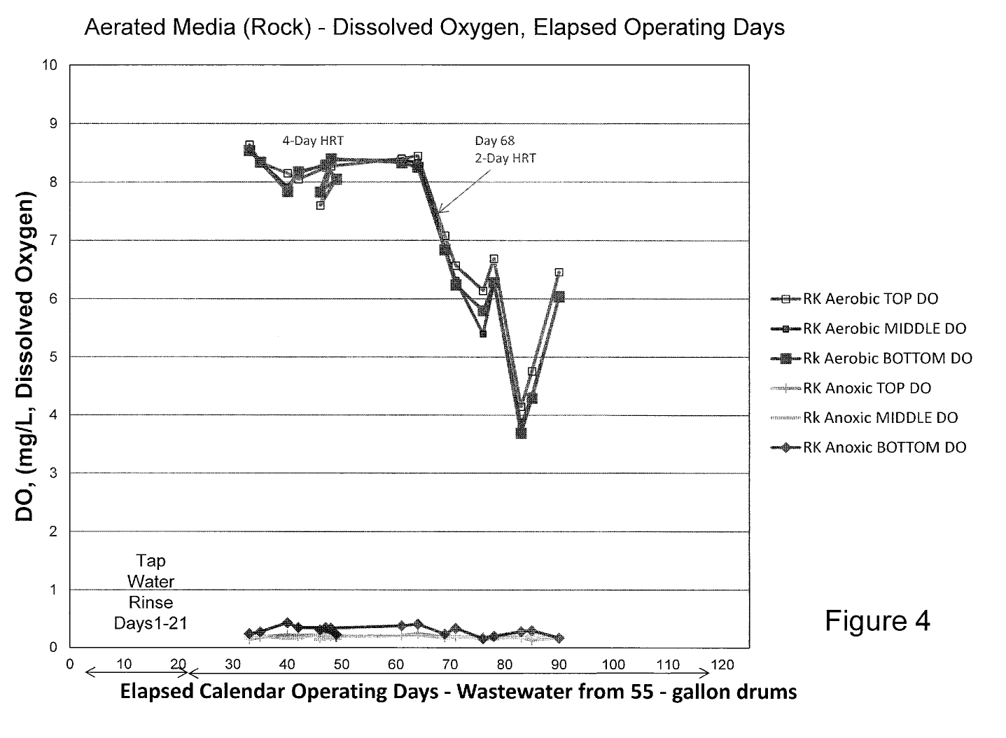

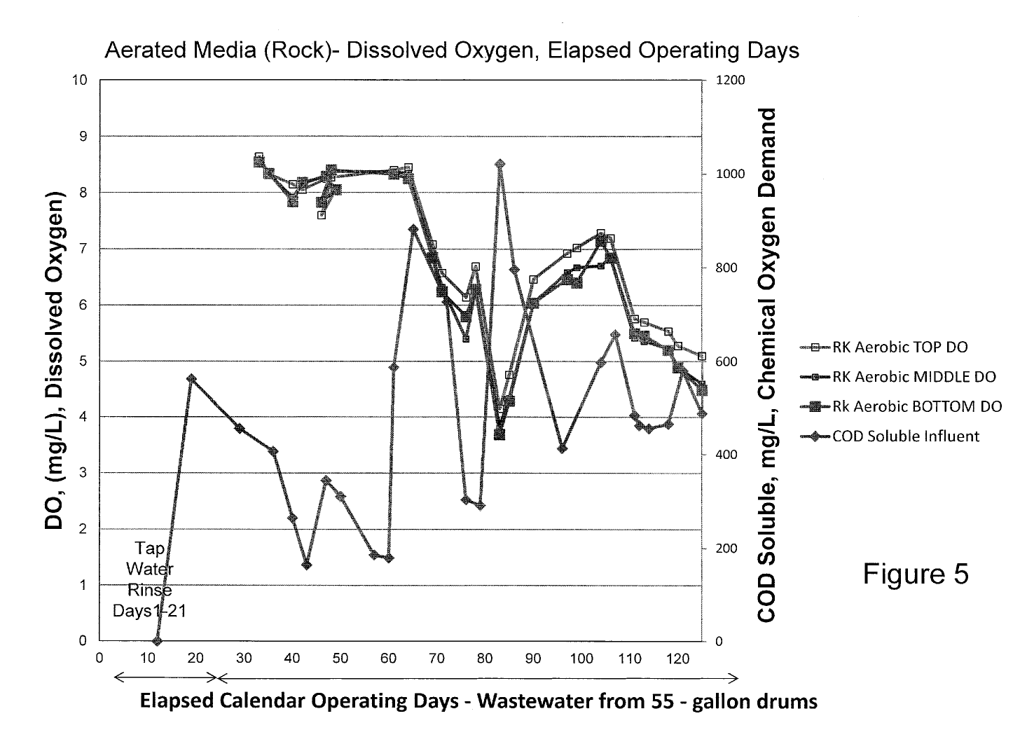

### DETAILED DESCRIPTION

The present disclosure provides systems and methods of effectively treating a wastewater stream to remove contaminants from the water, including: ammonia, biodegradable organics (e.g. BOD, CBOD), oils, greases, phosphorus, heavy metals, and combinations thereof. Reference will now be made in detail to the experimental examples and some of the figures, which at least assist in illustrating various pertinent embodiments of the present invention.

### EXAMPLES

### Example Pilot 1.0

A pilot wastewater treatment system was built having three zones: an aerated rock zone, a non-aerated compost zone; and an aerated pea gravel zone. The aerated rock zone included commercially available pond rocks (obtainable from a home improvement supply store). The amended compost zone included compost having not greater than 10 wt % of bauxite residue added. The amended compost filled the majority of the zone, and included pond rocks on the upper-most region to retain the compost in place. The pea gravel zone included commercially available pea gravel (obtainable from a home improvement supply store). The pea gravel had a much smaller average media size as compared to the pond rocks. The pea gravel section included vegetation (e.g. cattails) rooted in and growing from the pea gravel. Both the pond rocks section and pea gravel section were aerated via aeration systems that included commercially available aquarium tubing and aeration components. Air was pumped into the aeration system, which distributed air along the lowermost portion of each aerated media zone. The three zones (rocks, amended compost, pea gravel with vegetation) were separated with vertical baffles (i.e. to define a flow path through each zone in the system and prevent short circuiting).

The Pilot was operated indoors, with the influent wastewater stream (e.g. including an emulsified oil stream) previously collected and retained in a 55 gallon drum, where wastewater was fed from the drum into the aerated rocks zone of the pilot.

The wastewater was combined industrial wastewater (e.g. having a content of emulsified oil suspended in the wastewater) and sanitary wastewater. The 1.0 pilot was operated for a period of 114 consecutive days. In Table 1 below, the influent, effluent, and % removal oil & grease values are provided for days in which samples were taken.

TABLE 1
Pilot 1.0 - Influent, Effluent, % Removal, and HRT

| | | | % | HRT - Days | Sample |
|---|---|---|---|---|---|
| Day # | Influent | Effluent | Removal | (0.35 porosity) | Volume (L) |
| 1 | 188 | <5 | 97.3 | ~7.4 | 1 |
| 15 | 136 | <5 | 96.3 | ~7.4 | 1 |
| 29 | 242 | <5 | 97.9 | ~7.4 | 1 |
| 93 | 161 | 8 | 95 | ~3.3 | 1 |
| 100 | 226 | 8 | 96.5 | ~3.3 | 1 |
| 114 | 382 | 6 | 98.4 | ~2.2 | 1 |

Based on the above-table, it is shown that the pilot operated to remove above 80% of oil and grease from the wastewater stream in all measured instances. In nearly all instances, removal rates were above 90%. We note that the detection limit in the effluent was 5, so <5 denotes below detection limit (bdl) values.

Subsequently, the pilot was moved to an outdoor location in a mild climate, in order to test the pilot's operation capabilities in an outdoor environment with a real-time wastewater stream (e.g. combined wastewater stream of industrial wastewater (e.g. emulsified oil content) and a sanitary wastewater stream.

The pilot (“Pilot 1.1”) was operated for two periods of time. During the first period, the system operated as expected, with generally high influent oil & grease content, e.g. an influent of 320, an effluent of 5.2 and a removal rate of 98.4%. During a second growing season, additional data was obtained over a 149 day period of time, with a representative data set from the second growing season provided in Table 2 below.

TABLE 2
Pilot 1.1 Influent, Effluent, % Removal

| | | | removal |
|---|---|---|---|
| Day | Influent | Effluent | % |
| 1 | 641 | <5 | 99.2 |
| 15 | 84.8 | <5 | 94.1 |
| 50 | 456 | 12.3 | 97.3 |
| 64 | 152 | 7.4 | 95.1 |
| 70 | 743 | 28.3 | 96.2 |
| 85* | 1310 | 359 | 72.6 |
| 112 | 199 | 13.5 | 93.2 |
| 122 | 155 | <5 | 96.8 |
| 128 | 83 | <5 | 94.0 |
| 135 | 127 | <5 | 96.1 |
| 142 | 127 | <5 | 96.1 |
| 149 | 11.2 | 6.4 | 42.9 |

We note that the detection limit in the effluent was 5, so <5 denotes below detection limit (bdl) values. The asterisk in day 85 denotes a very high influent oil and grease stream, with visual observation of white effluent from the system. Pilot 1.1 was operating above 100 mL/min.

### Pilot 2.0: Comparison of Aerated Zone to Non-Aerated Zone, Followed by Non-Aerated Compost

In order to evaluate the impact of aeration in the first portion, two wastewater treatment systems were constructed and operated in parallel, the wastewater treatment systems having identical sizes, flow parameters, and media in the first and second portions (e.g. rocks and compost, respectively). The difference was in one system, the first portion (rocks) were aerated, while in the other system, the rocks were not aerated. For the portion with Aerated Rocks, the aeration system was a whisper pump, which operated at a flow rate of 5 scfh, corresponding to a flow rate of 2.36 lpm (atmospheric air).

After the wastewater was directed through the first zone (i.e. aerated or non-aerated rock chamber) of each system in an up-flow (reverse gravity) direction, the wastewater was then directed through the non-aerated compost section of each system in an up-flow (reverse gravity) direction. For each system, both the rock media (pond rocks) and the compost media (e.g. spent mushroom compost) were obtained at a home improvement supply store.

Pilot 2.0 was operated continuously, and the following oil & grease measurements were obtained from the aerated rocks section followed by the non-aerated compost section. The oil and grease measurements were made by an analytical lab (where sample 2 was taken 48 days after sample 1) and are depicted in Table 3 below. The Table depicts the impact of both the aerated rocks followed by the non-aerated compost. We note that the detection limit of the effluent stream is 5, so <5 is below detection limits.

TABLE 3

| | | Rocks | | Compost | % Removal |
|---|---|---|---|---|---|
| | Influent | Effluent | % Removal | Effluent | via |
| | O&G | O&G | via Rocks | O&G | Compost |
| | (mg/L) | (mg/L) | zone | (mg/L) | zone |
| Sample 1 | 120 | 78.1 | 34.9 | 5.2 | 93.3 |
| Sample 2 | 90.2 | 16.7 | 81.5 | <5.0 | 70.1 |

The pilot with an aerated first zone (e.g. rocks) achieved lower O&G effluent Concentration than the pilot without aeration. Data is depicted in Table 4 below. We note that <5 indicates a measurement below detection limits.

TABLE 4

| | | Pilot | | Pilot | | |
|---|---|---|---|---|---|---|
| | | with | | without | | |
| | | Air | Aerobic | Air | Anoxic | HRT- |
| Day | Influent | Effluent | % Removal | Effluent | % Removal | Days |
| 1 | 78.8 | <5.0 | >93 | <5.0 | >93 | 4 |
| 28 | 158 | 11.3 | >92 | 118 | >25 | 2 |
| 38 | 357 | 22.5 | >93 | 200 | >43 | 2 |
| 73 | 326 | 19.4 | >94 | 107 | >67 | 1 |
| 80 | 211 | 36.6 | >82 | 86 | >59 | 0.5 |

Also, COD values were also measured across both system components (aerated rock, non-aerated rock, non-aerated compost following aerated rock, and non-aerated compost following non-aerated rock). COD was utilized as a means of quantifying oil and grease removal, as oil & grease would be the predominant carbon source of any COD measurement. Table 5 provides data taken over a period of 57 days, depicting the impact of compost on oil and grease removal from the wastewater stream.

TABLE 5

| | | | Rocks | | Compost | | |
|---|---|---|---|---|---|---|---|
| | | Influent | Effluent | % Removal | Effluent | % Removal | Total % |
| | HRT | COD | COD | via | COD | via | Removal |
| Day | (days) | (mg/L) | (mg/L) | Rocks | (mg/L) | Compost | System |
| 1 | 8 | 455 | 117 | 74 | 93 | 21 | 80 |
| 8 | 4 | 406 | 174 | 57 | 110 | 37 | 73 |
| 15 | 4 | 164 | 140 | 15 | 132 | 6 | 20 |
| 22 | 4 | 310 | 119 | 62 | 113 | 5 | 64 |
| 29 | 4 | 185 | 154 | 17 | 122 | 21 | 34 |
| 36 | 2 | 882 | 185 | 79 | 107 | 42 | 88 |
| 50 | 2 | 291 | 144 | 51 | 135 | 6 | 54 |
| 57 | 2 | 796 | 248 | 69 | 207 | 17 | 74 |

The ORP was measured in each section, and the average aerobic rock ORP (e.g. taken at the middle section) was +142 mV, while the average anoxic compost value ORP was −52 mV.

Condensed Excel spreadsheet with (1) influent and effluent COD to show that compost is needed, (2) ORP and DO for rock chambers and (3) ORP and DO for Compost Chambers.

Without being bound by a particular mechanism or theory, the bottom section of the compost is believed to have had higher ORP measurements due to at least one of the following two reasons: (1) the influent to compost chamber is coming from aerated rock chamber, and/or (2) the experimental equipment is configured with a siphon break on the rock chambers, which may act to pull in air (e.g. add oxygen) to the compost influent stream.

Each of the zones was configured with three sampling cells. During sampling, a valve in the sampling cell was opened to allow water to flow into the cell. Sampling is completed, and the sampling cell (with wastewater) was flushed with fresh solution, driving the wastewater sample to exit through the tubing in the system.

In order to obtain ORP and DO measurements, a probe sensor was positioned in the sampling cell, with a stopper positioned above and around the probe to reduce/limit the amount of ambient air (e.g. O₂ from outside the system) that could come into contact with the wastewater sample.

TABLE 6
Comparison Data: COD Influent vs.
Effluent, COD Total & Soluble

| | | | Aerated or non-aerated |
|---|---|---|---|
| | Influent | Cumulative | HRT, 2-Tank systems, |
| | Pumped | Influent | 34 L @ 0.35 |
| | Vol., | Vol., | Porosity, |
| Days | L/day | Total L | Days |
| 19 | 28.80 | 489.6 | 14.40 |
| 29 | 4.90 | 572.0 | 16.82 |
| 33 | 9.79 | 596.4 | 17.54 |
| 36 | 9.79 | 625.8 | 18.41 |
| 40 | 9.79 | 665.0 | 19.56 |
| 43 | 9.79 | 694.4 | 20.42 |
| 47 | 9.79 | 733.5 | 21.57 |
| 50 | 9.79 | 762.9 | 22.44 |
| 54 | 9.79 | 772.7 | 22.73 |
| 57 | 9.79 | 802.1 | 23.59 |
| 60 | 9.79 | 831.4 | 24.45 |
| 61 | 9.79 | 841.2 | 24.74 |
| 65 | 9.79 | 870.6 | 25.61 |
| 69 | 19.58 | 929.3 | 27.33 |
| 72 | 19.58 | 988.1 | 29.06 |
| 76 | 19.58 | 1,066.4 | 31.36 |
| 78 | 19.58 | 1,105.6 | 32.52 |
| 79 | 19.58 | 1,125.1 | 33.09 |
| 80 | 19.58 | 1,144.7 | 33.67 |
| 83 | 19.58 | 1,203.5 | 35.40 |
| 86 | 19.58 | 1,262.2 | 37.12 |
| 90 | 9.79 | 1,301.4 | 38.28 |
| 96 | 9.79 | 1,360.1 | 40.00 |
| 104 | 16.90 | 1,445.5 | 42.52 |
| 107 | 16.90 | 1,496.2 | 44.01 |
| 111 | 26.78 | 1,583.6 | 46.58 |
| 112 | 26.78 | 1,610.4 | 47.36 |
| 114 | 26.78 | 1,663.9 | 48.94 |
| 118 | 26.78 | 1,751.3 | 51.51 |
| 121 | 16.90 | 1,821.8 | 53.58 |
| 125 | 43.92 | 1,943.4 | 57.16 |
| 126 | 43.92 | 1,987.3 | 58.45 |
| 127 | 43.92 | 2,031.2 | 59.74 |
| 128 | 43.92 | 2,075.2 | 61.03 |

TABLE 7

| | | | | | | | | | Not- | Not- |
|---|---|---|---|---|---|---|---|---|---|---|
| | | | | | Rock | Rock | Aerated | Aerated | aerated | aerated |
| | | | Rock | Rock | Non- | Non- | Effluent | Effluent | Effluent | Effluent |
| | | | Aerated | Aerated | aerated | aerated | Total | Soluble | Total | Soluble |
| | Influent | Influent | Effluent | Effluent | Effluent | Effluent | COD, | COD, | COD, | COD, |
| | Total | Soluble | Total | Soluble | Total | Soluble | mg/L | mg/L | mg/L | mg/L |
| | COD, | COD, | COD, | COD, | COD, | COD, | After | After | After | After |
| Days | mg/L | mg/L | mg/L | mg/L | mg/L | mg/L | Compost | Compost | Compost | Compost |
| 19 | 0 | 562 | | | | | 28 | | 58 | |
| 29 | 1196 | 455 | 249 | 117 | 520 | 202 | 102 | 93 | 80 | 58 |
| 33 | | | | | | | 120 | 120 | 218 | 165 |
| 36 | 960 | 406 | 800 | 174 | 600 | 287 | 120 | 110 | 198 | 148 |
| 40 | 590 | 264 | | | | | 190 | 147 | 196 | 165 |
| 43 | 312 | 164 | 292 | 140 | 478 | 146 | 131 | 132 | 150 | 142 |
| 47 | 608 | 344 | | | | | 153 | 120 | 127 | 117 |
| 50 | 482 | 310 | 183 | 119 | 610 | 178 | 100 | 113 | 135 | 120 |
| 54 | | | | | | | 96 | 98 | 114 | 99 |
| 57 | 232 | 185 | 319 | 154 | 255 | 178 | 133 | 122 | 152 | 162 |
| 60 | 194 | 179 | 212 | 114 | 285 | 150 | 141 | 126 | 145 | 136 |
| 61 | 944 | 587 | | | | | | | | |
| 65 | 1298 | 882 | 970 | 185 | 680 | 396 | 138 | 107 | 224 | 146 |
| 69 | | | | | | | 170 | 136 | 405 | 261 |
| 72 | 1168 | 727 | 1500 | 249 | 1319 | 703 | 182 | 148 | 556 | 355 |
| 76 | 826 | 303 | | | | | 165 | 121 | 584 | 363 |
| 78 | | | | | | | 146 | 151 | 378 | 196 |
| 79 | 880 | 291 | 436 | 144 | | 213 | 157 | 135 | 301 | 139 |
| 80 | 6000 | | | | | | | | | |
| 83 | 2230 | 1021 | | | | | 234 | 172 | 1053 | 379 |
| 86 | 1434 | 796 | 938 | 248 | 1415 | 690 | 273 | 207 | 858 | 502 |
| 90 | | | | | | | 322 | 218 | 649 | 431 |
| 96 | 893 | 413 | 657 | 190 | 1121 | 425 | 275 | 195 | 463 | 301 |
| 104 | 1117 | 598 | | | | | 205 | 159 | 348 | 238 |
| 107 | 1093 | 658 | 498 | 125 | 1342 | 526 | 165 | 145 | 464 | 336 |
| 111 | 1187 | 484 | | | | | 175 | 134 | 526 | 353 |
| 112 | 1046 | 462 | | | | | 150 | 121 | 502 | 360 |
| 114 | 1286 | 456 | 591 | 117 | 780 | 406 | 137 | 90 | 468 | 308 |
| 118 | 1093 | 465 | | | | | 152 | 114 | | |
| 121 | 1303 | 580 | 547 | 172 | 1555 | 417 | 172 | 116 | 438 | 300 |
| 125 | 656 | 488 | | | | | 261 | 193 | | |
| 126 | 907 | 663 | | | | | 250 | 234 | | |
| 127 | | | | | | | 204 | 133 | | |
| 128 | 999 | 441 | 457 | 129 | 537 | 290 | 231 | 98 | 398 | 245.0 |

TABLE 8

| | | Not- | | Not- |
|---|---|---|---|---|
| | Aerated | aerated | Aerated | aerated |
| | Effluent | Effluent | Effluent | Effluent |
| | Total | Total | Soluble | Soluble |
| | COD, % | COD, % | COD, % | COD, % |
| | Removal | Removal | Removal | Removal |
| | After | After | After | After |
| Days | Compost | Compost | Compost | Compost |
| 19 | 95.0 | 89.7 | | |
| 29 | 91.5 | 93.3 | 79.6 | 87.3 |
| 33 | 90.0 | 81.8 | 73.6 | 63.7 |
| 36 | 87.5 | 79.4 | 72.9 | 63.5 |
| 40 | 67.8 | 66.8 | 44.3 | 37.5 |
| 43 | 58.0 | 51.9 | 19.5 | 13.4 |
| 47 | 74.8 | 79.1 | 65.1 | 66.0 |
| 50 | 79.3 | 72.0 | 63.5 | 61.3 |
| 54 | 80.1 | 76.3 | 68.4 | 68.1 |
| 57 | 42.7 | 34.5 | 34.1 | 12.4 |
| 60 | 27.3 | 25.3 | 29.6 | 24.0 |
| 65 | 89.4 | 82.7 | 87.9 | 83.4 |
| 69 | 86.9 | 68.8 | 84.6 | 70.4 |
| 72 | 86.0 | 57.2 | 83.2 | 59.8 |
| 76 | 85.9 | 50.0 | 83.4 | 50.1 |
| 78 | 82.3 | 54.2 | 50.2 | 35.3 |
| 79 | 82.2 | 65.8 | 53.6 | 52.2 |
| 83 | 89.5 | 52.8 | 83.2 | 62.9 |
| 86 | 81.0 | 40.2 | 74.0 | 36.9 |
| 90 | 77.5 | 54.7 | 72.6 | 45.9 |
| 96 | 69.2 | 48.2 | 52.8 | 27.1 |
| 104 | 81.6 | 68.8 | 73.4 | 60.2 |
| 107 | 84.9 | 57.5 | 78.0 | 48.9 |
| 111 | 85.3 | 55.7 | 72.3 | 27.1 |
| 112 | 85.7 | 52.0 | 73.8 | 22.1 |
| 114 | 89.3 | 63.6 | 80.3 | 32.5 |
| 118 | 86.1 | — | 75.5 | — |
| 121 | 86.8 | 66.4 | 80.0 | 48.3 |

TABLE 9

| | | Rock Not- | | Rock Not- |
|---|---|---|---|---|
| | Rock Aerated | aerated | Rock Aerated | aerated |
| | Effluent | Effluent | Effluent | Effluent |
| | Total COD, | Total COD, | Soluble COD, | Soluble COD, |
| Days | % Removal | % Removal | % Removal | % Removal |
| 29 | 79.2 | 56.5 | 74.3 | 55.6 |
| 36 | 16.7 | 60.0 | 57.1 | 29.3 |
| 43 | 50.5 | 19.0 | 47.0 | 44.7 |
| 50 | 69.9 | −0.3 | 65.4 | 48.3 |
| 57 | 33.8 | 47.1 | 50.3 | 42.6 |
| 60 | 8.6 | −22.8 | 38.4 | 18.9 |
| 65 | −2.8 | 28.0 | 68.5 | 32.5 |
| 72 | −15.6 | −1.6 | 71.8 | 20.3 |

TABLE 10
Comparison Data: DO, ORP Data for the Rocks (aerated vs, non-aerated)

| | | | | | | | DO | DO | DO |
|---|---|---|---|---|---|---|---|---|---|
| | | | HRT, | DO | DO | DO | Non- | Non- | Non- |
| | | Cuml. | 2-Tank sys, | Aerated | Aerated | Aerated | aerated | aerated | aerated |
| | Infl. | Influent | 34 L @ 0.35 | Rocks | Rocks | Rocks | Rocks | Rocks | Rocks |
| | Vol., | Vol., | Porosity | Top | Middle | Bottom | Top | Middle | Bottom |
| Days | L/day | Total L | Days | mg/L | mg/L | mg/L | mg/L | mg/L | mg/L |
| 33 | 9.79 | 596.4 | 17.54 | 8.64 | 8.56 | 8.54 | 0.14 | 0.16 | 0.24 |
| 35 | 9.79 | 616.0 | 18.12 | 8.33 | 8.34 | 8.34 | 0.18 | 0.20 | 0.27 |
| 40 | 9.79 | 665.0 | 19.56 | 8.15 | 7.92 | 7.84 | 0.22 | 0.16 | 0.43 |
| 42 | 9.79 | 684.6 | 20.13 | 8.05 | 8.16 | 8.18 | 0.21 | 0.17 | 0.35 |
| 47 | 9.79 | 733.5 | 21.57 | 8.25 | 8.30 | 8.29 | 0.22 | 0.24 | 0.35 |
| 49 | 9.79 | 753.1 | 22.15 | 8.06 | 8.02 | 8.05 | 0.18 | 0.16 | 0.23 |
| 46 | 9.79 | 802.1 | 23.59 | 7.60 | 7.86 | 7.83 | 0.17 | 0.15 | 0.31 |
| 48 | 9.79 | 821.7 | 24.17 | 8.27 | 8.38 | 8.40 | 0.20 | 0.20 | 0.34 |
| 61 | 9.79 | 870.6 | 25.61 | 8.40 | 8.37 | 8.33 | 0.21 | 0.21 | 0.38 |
| 64 | 9.79 | 890.2 | 26.18 | 8.45 | 8.34 | 8.25 | 0.25 | 0.22 | 0.41 |
| 69 | 19.58 | 958.7 | 28.20 | 7.08 | 6.87 | 6.84 | 0.18 | 0.17 | 0.24 |
| 71 | 19.58 | 997.9 | 29.35 | 6.57 | 6.32 | 6.24 | 0.19 | 0.20 | 0.34 |
| 76 | 19.58 | 1,095.8 | 32.23 | 6.14 | 5.40 | 5.80 | 0.18 | 0.15 | 0.16 |
| 78 | 19.58 | 1,134.9 | 33.38 | 6.69 | 6.29 | 6.28 | 0.20 | 0.16 | 0.20 |
| 83 | 19.58 | 1,232.8 | 36.26 | 4.15 | 3.83 | 3.69 | 0.18 | 0.18 | 0.28 |
| 85 | 19.58 | 1,272.0 | 37.41 | 4.76 | 4.34 | 4.29 | 0.13 | 0.21 | 0.30 |
| 90 | 9.79 | 1,330.7 | 39.14 | 6.46 | 6.04 | 6.04 | 0.18 | 0.19 | 0.17 |
| 97 | 9.79 | 1,399.3 | 41.16 | 6.92 | 6.58 | 6.46 | 0.18 | 0.17 | 0.23 |
| 99 | 9.79 | 1,418.9 | 41.73 | 7.02 | 6.67 | 6.40 | 0.18 | 0.19 | 0.31 |
| 104 | 16.90 | 1,474.9 | 43.38 | 7.28 | 6.70 | 7.14 | 0.17 | 0.19 | 0.34 |
| 106 | 16.90 | 1,508.7 | 44.37 | 7.19 | 6.85 | 6.84 | 0.18 | 0.21 | 0.37 |
| 111 | 26.78 | 1,613.0 | 47.44 | 5.76 | 5.42 | 5.50 | 0.16 | 0.17 | 0.23 |
| 113 | 26.78 | 1,666.5 | 49.02 | 5.70 | 5.36 | 5.46 | 0.17 | 0.19 | 0.34 |
| 118 | 26.78 | 1,780.7 | 52.37 | 5.54 | 5.23 | 5.20 | 0.19 | 0.16 | 0.29 |
| 120 | 26.78 | 1,834.2 | 53.95 | 5.28 | 4.90 | 4.89 | 0.19 | 0.20 | 0.46 |
| 125 | 43.92 | 1,972.8 | 58.02 | 5.10 | 4.60 | 4.49 | 0.18 | 0.16 | 0.11 |
| 127 | 43.92 | 2,060.6 | 60.61 | 4.12 | 3.60 | 3.42 | | | |
| | | | SUM | 183.96 | 177.25 | 177.03 | 4.82 | 4.77 | 7.68 |
| | | | Avg | 6.81 | 6.56 | 6.56 | 0.19 | 0.18 | 0.30 |

TABLE 11

| | | | HRT, | | | | | | |
|---|---|---|---|---|---|---|---|---|---|
| | | | 2-Tank | | | | ORP | ORP | ORP |
| | | | sys | ORP | ORP | ORP | Non- | Non- | Non- |
| | | Cuml. | 34 L @ | Aerated | Aerated | Aerated | aerated | aerated | aerated |
| | Infl. | Influent | 0.35 | Rocks | Rocks | Rocks | Rocks | Rocks | Rocks |
| | Vol., | Vol., | Porosity | Top | Middle | Bottom | Top | Middle | Bottom |
| Days | L/day | Total L | Days | mV | mV | mVL | mV | mV | mV |
| 33 | 9.79 | 596.4 | 17.54 | 190 | 169 | 161 | −120 | −128 | −120 |
| 35 | 9.79 | 616.0 | 18.12 | 148 | 140 | 132 | −210 | −215 | −220 |
| 40 | 9.79 | 665.0 | 19.56 | 204 | 184 | 172 | −155 | −182 | −166 |
| 42 | 9.79 | 684.6 | 20.13 | 173 | 158 | 148 | −130 | −177 | −173 |
| 47 | 9.79 | 733.5 | 21.57 | 174 | 154 | 149 | −119 | −181 | −192 |
| 49 | 9.79 | 753.1 | 22.15 | 136 | 125 | 124 | −192 | −216 | −214 |
| 46 | 9.79 | 802.1 | 23.59 | 130 | 133 | 135 | −202 | −217 | −212 |
| 48 | 9.79 | 821.7 | 24.17 | 150 | 139 | 138 | −159 | −193 | −194 |
| 61 | 9.79 | 870.6 | 25.61 | 138.5 | 130.4 | 129.3 | −164.4 | −195.4 | −198.5 |
| 64 | 9.79 | 890.2 | 26.18 | 129.2 | 127.1 | 128.3 | −187.6 | −207.2 | −210.1 |
| 69 | 19.58 | 958.7 | 28.20 | 143.7 | 136.3 | 133.5 | −206.2 | −226.5 | −224.6 |
| 71 | 19.58 | 997.9 | 29.35 | 176.4 | 157.8 | 148.1 | −225.2 | −223.9 | −230.7 |
| 76 | 19.58 | 1,095.8 | 32.23 | 141.1 | 134.3 | 141.7 | −218.2 | −263.3 | −234.6 |
| 78 | 19.58 | 1,134.9 | 33.38 | 132.2 | 129.4 | 131.6 | −154.4 | −191.1 | −200.4 |
| 83 | 19.58 | 1,232.8 | 36.26 | 138.1 | 132.3 | 129.8 | −240.4 | −253.1 | −247.6 |
| 85 | 19.58 | 1,272.0 | 37.41 | 119.3 | 125.9 | 129.3 | −208.1 | −229.1 | −228.1 |
| 90 | 9.79 | 1,330.7 | 39.14 | 133.9 | 136.4 | 136.9 | −182.7 | −179.4 | −202.8 |
| 97 | 9.79 | 1,399.3 | 41.16 | | | | | | |
| 99 | 9.79 | 1,418.9 | 41.73 | | | | | | |
| 104 | 16.90 | 1,474.9 | 43.38 | | | | | | |
| 106 | 16.90 | 1,508.7 | 44.37 | | | | | | |
| 111 | 26.78 | 1,613.0 | 47.44 | | | | | | |
| 113 | 26.78 | 1,666.5 | 49.02 | | | | | | |
| 118 | 26.78 | 1,780.7 | 52.37 | | | | | | |
| 120 | 26.78 | 1,834.2 | 53.95 | | | | | | |
| 125 | 43.92 | 1,972.8 | 58.02 | | | | | | |
| 127 | 43.92 | 2,060.6 | 60.61 | | | | | | |
| | | | SUM | 2557.30 | 2412.10 | 2367.30 | −3074.40 | −3478.00 | −3468.20 |
| | | | Avg | 150.43 | 141.89 | 139.25 | −180.85 | −204.59 | −204.01 |

TABLE 12
Comparison Data: DO, ORP Data for the Compost (e.g. attached to aerated or non-
aerated rocks)

| | | | | | | | DO | DO | DO |
|---|---|---|---|---|---|---|---|---|---|
| | | | HRT, | DO | DO | DO | Non- | Non- | Non- |
| | | | 2-Tank | Aerated | Aerated | Aerated | aerated | aerated | aerated |
| | | | sys, | Rock | Rock | Rock | Rock | Rock | Rock |
| | | Cuml | 34 L @ | Compost | Compost | Compost | Compost | Compost | Compost |
| | Infl. | Influent | 0.35 | (No air) | (No air) | (No air) | (No air) | (No air) | (No air) |
| | Vol., | Vol., | Porosity, | Top | Middle | Bottom | Top | Middle | Bottom |
| Days | L/day | Total L | Days | mg/L | mg/L | mg/L | mg/L | mg/L | mg/L |
| 34 | 9.79 | 606.2 | 17.83 | 0.22 | 0.14 | 1.46 | 0.15 | 0.14 | 1.00 |
| 36 | 9.79 | 625.8 | 18.41 | 0.26 | 0.21 | 1.42 | 0.14 | 0.15 | 0.61 |
| 41 | 9.79 | 674.8 | 19.85 | 0.27 | 0.20 | 1.57 | 0.17 | 0.13 | 0.60 |
| 43 | 9.79 | 694.4 | 20.42 | 0.33 | 0.18 | 1.69 | 0.17 | 0.17 | 0.48 |
| 48 | 9.79 | 743.3 | 21.86 | 0.50 | 0.20 | 1.63 | 0.16 | 0.14 | 0.55 |
| 50 | 9.79 | 762.9 | 22.44 | 0.76 | 0.26 | 1.59 | 0.15 | 0.15 | 0.49 |
| 55 | 9.79 | 811.9 | 23.88 | 1.89 | 0.17 | 1.72 | 0.18 | 0.15 | 0.61 |
| 57 | 9.79 | 831.5 | 24.45 | 0.64 | 0.24 | 1.77 | 0.18 | 0.16 | 0.71 |
| 62 | 9.79 | 880.4 | 25.89 | 0.58 | 0.26 | 1.55 | 0.19 | 0.16 | 0.75 |
| 65 | 9.79 | 900.0 | 26.47 | 0.70 | 0.20 | 1.84 | 0.17 | 0.15 | 0.66 |
| 70 | 19.58 | 978.3 | 28.77 | 0.55 | 0.26 | 1.66 | 0.19 | 0.18 | 0.68 |
| 72 | 19.58 | 1,017.5 | 29.93 | 0.31 | 0.17 | 1.40 | 0.16 | 0.13 | 0.73 |
| 77 | 19.58 | 1,115.4 | 32.80 | 0.39 | 0.24 | 1.17 | 0.17 | 0.14 | 0.59 |
| 79 | 19.58 | 1,154.5 | 33.96 | 0.61 | 0.28 | 1.48 | 0.14 | 0.13 | 0.75 |
| 84 | 19.58 | 1,252.4 | 36.84 | 0.28 | 0.16 | 1.30 | 0.20 | 0.17 | 0.64 |
| 86 | 19.58 | 1,291.6 | 37.99 | 0.28 | 0.16 | 1.09 | 0.17 | 0.14 | 0.47 |
| | | | SUM | 8.57 | 3.33 | 24.34 | 2.69 | 2.39 | 10.32 |
| | | | Average | 0.54 | 0.21 | 1.52 | 0.17 | 0.15 | 0.65 |

TABLE 13

| | | | | | | | ORP | ORP | ORP |
|---|---|---|---|---|---|---|---|---|---|
| | | | HRT, | ORP | ORP | ORP | Non- | Non- | Non- |
| | | | 2-Tank | Aerated | Aerated | Aerated | aerated | aerated | aerated |
| | | | sys, | Rock | Rock | Rock | Rock | Rock | Rock |
| | | Cuml | 34 L @ | Compost | Compost | Compost | Compost | Compost | Compost |
| | Infl. | Influent | 0.35 | (No air) | (No air) | (No air) | (No air) | (No air) | (No air) |
| | Vol., | Vol., | Porosity, | Top | Middle | Bottom | Top | Middle | Bottom |
| Days | L/day | Total L | Days | mV | mV | mV | mV | mV | mV |
| 34 | 9.79 | 606.2 | 17.83 | −30 | −170 | −98 | −175 | −157 | −177 |
| 36 | 9.79 | 625.8 | 18.41 | −60 | −108 | −53 | −105 | −103 | −77 |
| 41 | 9.79 | 674.8 | 19.85 | 174 | −20 | 25 | −81 | −104 | −66 |
| 43 | 9.79 | 694.4 | 20.42 | 170 | −41 | 14 | −104 | −109 | −110 |
| 48 | 9.79 | 743.3 | 21.86 | 154 | −47 | 10 | 4 | −130 | −111 |
| 50 | 9.79 | 762.9 | 22.44 | 141 | −77 | −32.4 | 25 | −150 | −129 |
| 55 | 9.79 | 811.9 | 23.88 | 152 | −109 | −21 | −98 | −149 | −162 |
| 57 | 9.79 | 831.5 | 24.45 | 140.5 | −68.6 | −3.5 | 3.8 | −134.4 | −129.9 |
| 62 | 9.79 | 880.4 | 25.89 | 143.3 | −22.4 | 101.8 | 99.5 | −123.9 | −123.0 |
| 65 | 9.79 | 900.0 | 26.47 | 136.6 | −38.0 | 0.4 | 56.1 | −118.3 | −119.5 |
| 70 | 19.58 | 978.3 | 28.77 | 138.4 | −65.9 | −24.5 | 7.90 | −139.3 | −135.3 |
| 72 | 19.58 | 1,017.5 | 29.93 | 130.8 | −18.7 | 36.4 | −100.3 | −160.7 | −111.0 |
| 77 | 19.58 | 1,115.4 | 32.80 | 138.1 | 21.2 | 45.7 | −3.4 | −158.0 | −86.8 |
| 79 | 19.58 | 1,154.5 | 33.96 | 122.7 | 36.3 | 49.8 | 47.4 | −175.5 | −149.0 |
| 84 | 19.58 | 1,252.4 | 36.84 | 99.0 | 0.7 | 61.5 | −198.8 | −216.0 | −230.0 |
| 86 | 19.58 | 1,291.6 | 37.99 | 79.7 | −112.2 | −45.8 | −215 | −222 | −229 |
| | | | SUM | 1830.10 | −839.60 | 66.40 | −837.20 | −2350.30 | −1899.50 |
| | | | Average | 114.38 | −52.48 | 4.15 | −52.33 | −146.89 | −118.72 |

### Pilot 3.0 Three-Zone System (Aerated Rocks, Non-Aerated Compost, Aerated Rocks

Another bench-scale pilot was constructed, which included: a first zone of aerated rocks: a second zone of non-aerated compost, and a third zone of aerated rocks (e.g. zone three was identical to zone 1 in media and aeration components). Both zone 1 and 3 were configured with aeration systems (e.g. aquarium tubing with commercially available aquarium aeration components). Zones 1, 2, and 3 were separated by vertical baffles, which were configured with the tank of the system to define a flow path for wastewater to flow through zone 1, zone 2, and zone 3 of the system.

The rocks in the first and third zones were: pond rocks having an average surface area of 0.7 cm²/g and an average porosity of 35%. The compost in the second zone was spent mushroom compost (unmodified from commercially available form). Wastewater including a combined stream of sanitary and industrial wastewater (the industrial water having an emulsified oil content) was directed into the system via the inlet. The wastewater was directed through the aerated zone (rocks), through the non-aerated zone (compost), and then through an another aerated zone (rocks).

Both COD and oil & grease removal were monitored after the second portion (e.g. just after entry into the third zone). Pilot 3.0 was started at a four-day hydraulic retention time, and upon monitoring COD in the influent and effluent, flow rate was modified to operate the system at a two-day hydraulic retention time (i.e. once effluent COD was about 20% less than the influent COD. The emulsified oil content varied in the influent stream, as the content of the industrial water varied, though the influent emulsified oil content was never below 120 ppm during the monitoring period. Over the monitoring period, the average COD (influent) was 679 ppm, while the average COD (effluent) was 63 ppm, which corresponded with an average removal rate of 91%. The highest COD (influent to the system) was 11,050 ppm, with an effluent COD of 890 ppm, which corresponded to a COD Removal of 91.9%. The highest emulsified oil influent was 3,100 ppm, with an effluent oil content of 200 ppm, which corresponded to an average emulsified oil removal rate of 93.5%.

Reduction of water toxicity was measured/quantified via Short-Term Methods for Estimating the Chronic Toxicity of Effluents and Receiving Water to Freshwater Organisms; Fourth Edition Section 13, Cladoceran (Ceriodaphnia dubia) Survival and Reproduction Test Method 1002.0. The test criterion is pass/fail, which is based on the survival, i.e. quantifying the number of organisms that die in test media compared to control media. Also, reproduction is quantified, with the number of offspring in test media compared to offspring in control media over 5-7 day period. Data samples were obtained over a 66 day period, as depicted in Table 14 below. It is noted that influent data precedes effluent data for each HRT sampling.

TABLE 14

| | | COD | COD | | | | | Aquatic | |
|---|---|---|---|---|---|---|---|---|---|
| | | Total | Soluble | O&G | BOD | | | Acute | Aquatic |
| | HRT | mg/L | mg/L | mg/L | mg/L | Cond. | pH | Toxicity | Chronic |
| Day | (days) | 10 mL | 10 mL | 1 L | 0.5 L | us/cm | units | 1 L | Toxicity |
| 1 | 4 | 1010 | 540 | 214 | 199 | — | — | Fail | — |
| 1 | 4 | 181 | 174 | <5 | 12 | 1658 | 7.87 | Pass | Pass |
| 17 | 3 | 516 | 244 | 106 | — | — | 7.3 | Fail | — |
| 17 | 3 | 92 | 90 | <5 | — | 1048 | 7.6 | Pass | Pass |
| 24 | 4 | 1001 | 435 | 172 | — | — | — | Fail | — |
| 24 | 4 | 80 | 83 | <5 | — | — | — | Pass | Pass |
| 43 | 1 | 812 | 326 | 150 | 83 | 751 | 7.04 | Fail | — |
| 43 | 1 | 55 | 54 | <5.3 | <4 | 848 | 7.15 | Pass | Pass |
| 52 | 2 | 11,060 | 7,340 | 3100 | — | 1680 | 7.49 | Fail | — |
| 52 | 2 | 890 | 603 | 200 | — | 1465 | 7.64 | Fail | — |
| 66 | 4 | 6450 | 4380 | 1300 | — | 1212 | 7.04 | Fail | — |
| 66 | 4 | 284 | 251 | 15 | — | 1252 | 7.05 | Fail | — |

The various zones (aerated rock, non-aerated compost, aerated rock) were each equipped with sampling wells. Measurements of ammonia, nitrate, and nitrite were obtained, in order to better understand the removal of ammonia by the system components (e.g. nitrification, denitrification). Data in Table 15 shows the measurements obtained via Hach Test Kits for ammonia, nitrate, and nitrite.

TABLE 15
Ammonia, Nitrite, Nitrate, and Orthophosphate Hach Test Kit Results

| | | | LAF I- | | | | Effluent Rock | |
|---|---|---|---|---|---|---|---|---|
| | | | NEWT, | | Influent Rock | | Section, mg/L | |
| | HRT | Hach | mg/L | | Section, mg/L | | | Well |
| Day | Days | Test | Infl. | Effl. | Well A-S | Well A-D | Well C-S | C-D |
| 1 | 4 | *Ammonia-N | 25 | <0.3 | — | — | — | — |
| | | Ammonia-N | 26 | 0.09 | — | — | — | — |
| | | Nitrate-N | 0.1 | 0.2 | — | — | — | — |
| 17 | 3 | Ammonia-N | 38 | bdl | 2 | 3 | bdl | bdl |
| | | Nitrate-N | 7.7 | 0.6 | 0.2 | 0.7 | 0.6 | 0 |
| 22 | 2 | Ammonia-N | 11 | 0.03 | 0.12 | 0.1 | 0.04 | bdl |
| | | Nitrate-N | bdl | 0.2 | bdl | Bdl | 0.5 | bdl |
| | | Nitrite-N | 1.22 | 0.01 | 0.11 | 0.16 | 0.2 | bdl |

*Ammonia-N - Data from Commonwealth Biomonitoring (using ion specific probe)
Monitor Wells
S: Shallow well, ~6″ into media
D: Deep Well, ~18″ into media
A & B wells located in Inlet Rock Section
C, D, E, & F wells located in Effluent Rock Section

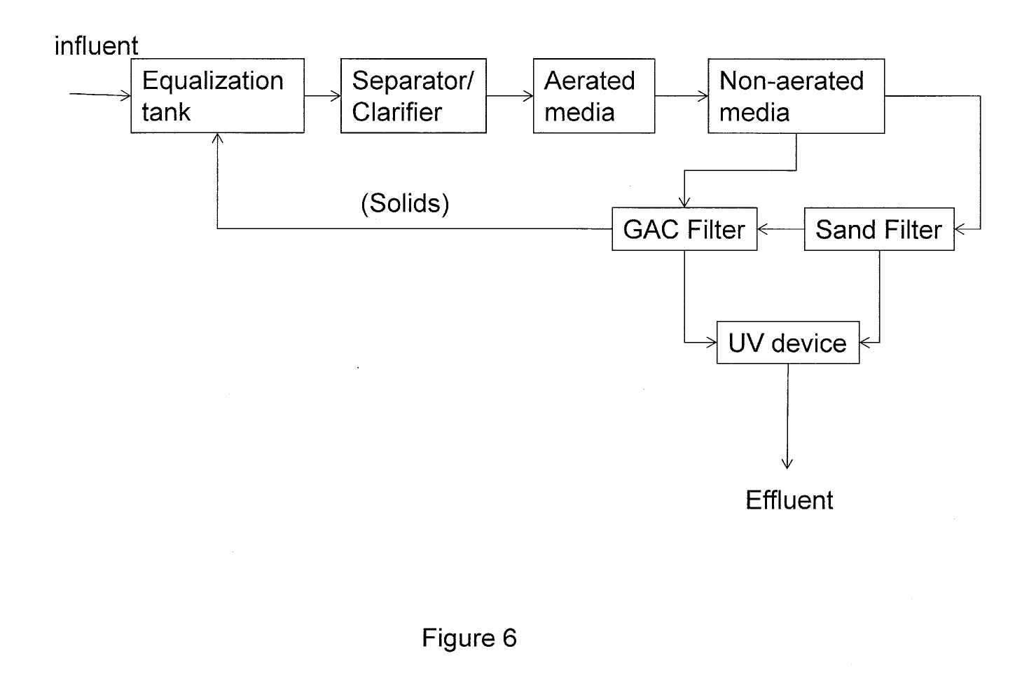

Referring to FIG. 6, a flow chart depicting a wastewater treatment system is provided. The flow chart includes an equalization tank, a free oil separator/clarifier (an filter, configured to remove separated oil, grease, and ferric chloride compounds from the chemical equalization step), an aerobic media section/chamber, a non-aerated compost section/chamber, a sand filter, a granular activated carbon (GAC) filter, and a UV disinfection source/device, followed by discharge of treated (cleaned & polished) wastewater from the system.

In some embodiments, the equalization tank is utilized to treat (e.g. pre-treat) water having an oil and/or grease content above a certain threshold with a chemical additive (e.g. ferric chloride) in order to remove some of the oil and grease from the water influent. In some embodiments, when the influent oil stream is above a certain threshold (i.e. 500 to greater than 10,000 ppm), a chemical additive (i.e. ferric chloride) is utilized as an emulsion breaker. In some embodiments, the equalization tank treats <10% of the wastewater with ferric chloride (i.e. occasional occurrences of “high oil” content, above a certain predetermined threshold).

In some embodiments, a vacuum filter is configured to remove filter cake and/or separated oil (e.g. after the equalization tank and/or the separation/clarifier chamber).

In some embodiments, an oil/water monitor will identify conditions when emulsion breaker treatment (e.g. equalization tank) is required. In some embodiments, the sand filter and GAC filter are configured to polish the wastewater to further remove contaminants and/or impurities from the wastewater stream. In these embodiments (i.e. where either sand or GAC filters are included), then backwash solids from the filters are sent back to the equalization tank. In some embodiments, effluent from the aerated media followed by non-aerated media is disinfected via ultraviolet light from a UV source/device.

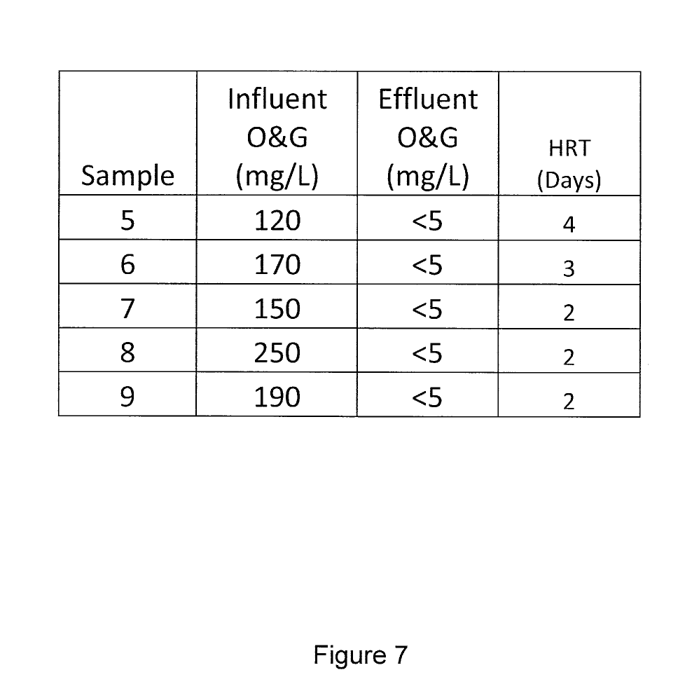

Another objective of this study outdoor pilot (1.1) was to observe performance of the system under cold (˜40° F.) conditions. Chillers were installed in the influent drum and first chamber of the unit. The plant facility's existing wastewater treatment system treats a blend of sanitary and multiple sources of industrial wastewater, including extrusion press waste water, cooling tower blow down and other miscellaneous process waste waters. Blending of these various streams generates a wastewater with a temperature of ˜50° F. Therefore the lab tests that were done at ˜40° F. were adequate to simulate winter operations. The table in FIG. 7 shows oil and grease effluent results for various influent oil and grease concentrations and hydraulic retention times (HRTs). The lower temperature has an insignificant effect on performance. All results meet permit limit <10 mg/L oil and grease.

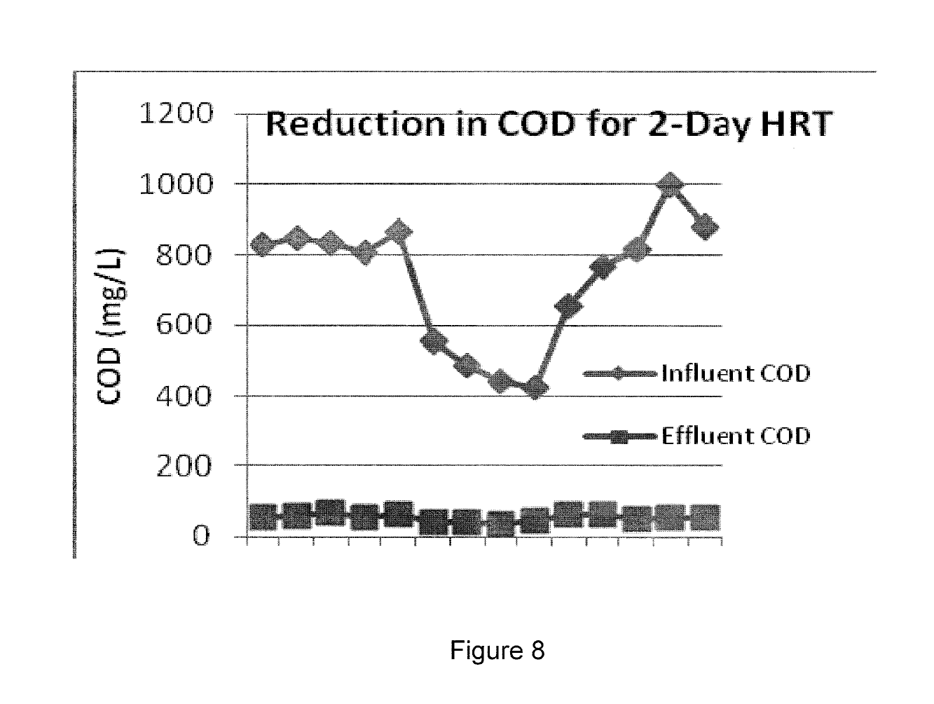

FIG. 8 is a graph of 2-Day HRT Carbon Oxygen Demand (COD) data for the cold weather unit. This test is commonly used to indirectly measure the amount of organic compounds in water. The graph shows that >90% COD is removed from the influent.

While various embodiments of the present invention have been described in detail, it is apparent that modifications and adaptations of those embodiments will occur to those skilled in the art. However, it is to be expressly understood that such modifications and adaptations are within the spirit and scope of the present invention.

What is claimed is:

1. A method of treating wastewater, comprising:
flowing a wastewater stream comprising an emulsified oil content of not greater than 3500 mg/L through a chamber at a hydraulic retention time of not greater than 5 days, the chamber comprising:
a bottom and at least one sidewall,
an influent end and an effluent end in liquid communication with a control volume in the tank, wherein the control volume is configured to retain the wastewater stream, the chamber comprising: an aerated zone and a non-aerated zone;
wherein the aerated zone includes:
a media configured to provide a surface for microorganisms to adhere to, wherein the media has an average surface area of not greater than 2.0 cm2/g; wherein the media comprises a porosity of not greater than 50%;
wherein the non-aerated portion includes compost;
treating the wastewater in the chamber via the two zones to remove at least 85% of emulsified oil & grease from the wastewater stream to provide a treated water stream; and
discharging the treated water stream from the chamber.

2. The method of claim 1, wherein the hydraulic retention time is from 0.5 days to 5 days.

3. The method of claim 1, wherein the hydraulic retention time is not greater than 0.5 days.

4. The method of claim 1, wherein the media has an average surface area of not greater than 2.0 cm²/g.

5. The method of claim 1, wherein the media comprises a porosity of at least 25% porosity to not greater than 50% porosity.

6. The method of claim 1, wherein the chamber comprises an engineered wetland.

7. The method of claim 1, wherein the engineered wetland is a subsurface flow wetland.

8. The method of claim 1, wherein the aerated zone is configured with an aeration system.

9. The method of claim 8, wherein the aeration system is configured to provide oxygen-containing air to the wastewater in the aerated zone.

10. The method of claim 1, wherein
treating further comprises treating via at least one of:
the microorganisms in the aerated portion;
adsorption onto the media;
the microorganisms in the compost portion; and
adsorption onto the compost; and combinations thereof.

11. The method of claim 1, wherein the wastewater comprises a pH of 6.5 to not greater than 8.5.

12. The method of claim 1, wherein the method comprises directing the water through a second zone of aerobic media.

13. The method of claim 1, wherein prior to the discharging step, the method comprises: directing the polished wastewater stream through a sensor zone, where the sensor is configured to measure the oil content in the water.

14. The method of claim 1, wherein the system is configured to operate in cold weather conditions.

15. The method of claim 1, wherein the method comprises removing at least 90% of PCBs from the wastewater stream.

16. The method of claim 15, wherein the method comprises removing an average of 95% of PCBs from the wastewater stream.

17. The method of claim 1, wherein the method comprises removing up to 92% of COD.

18. The method of claim 1, wherein the method is configured to treat wastewater having an influent COD of 11,000 mg/L.

19. The method of claim 1, wherein the method comprises removing up to 95% of oil and grease.

20. The method of claim 1, wherein the method comprises removing oil from a wastewater stream to below 20 ppm.

21. The method of claim 1, wherein the method comprises removing at least 50% ammonia from the wastewater stream.

22. The method of claim 1, wherein the method is configured to reduce water toxicity.

23. The method of claim 1, wherein the chamber includes baffles in the first portion/zone.

24. The method of claim 1, wherein the chamber includes baffles in the second portion/zone.

25. A method, comprising:
flowing wastewater having a first emulsified oil content of not greater than 3500 mg/L through an aerated zone having media therein, wherein via the aerated zone a portion of the emulsified oil is removed to provide a cleaned water stream;
flowing the cleaned water stream having a second emulsified oil content through a non-aerated zone having compost therein, wherein the second emulsified oil content is lower than the first emulsified oil content, wherein via the non-aerated zone of compost a portion of the emulsified oil in the cleaned water stream is removed to provide a polished water stream, the polished water stream comprising a third emulsified oil content, wherein the third emulsified oil content is lower than the second emulsified oil content; and
discharging a polished water stream from the non-aerated zone.

26. The method of claim 25, wherein prior to the discharging step, the method comprises: directing the polished wastewater stream through a sensor zone, where the sensor is configured to measure the oil content in the water.

27. The method of claim 26, wherein the sensor is configured with a control system, wherein the control system is configured to redirect the water through a feedback loop to remove additional oil and grease.
